(19) United States
(12) Patent Application Publication
(10) Pub. No.: US 2012/0112983 A1
(43) Pub. Date: May 10, 2012

(54) Single Array Antenna for Coverage of a Venue

(76) Inventor: Robert Mathews, Sunland, CA (US)

(21) Appl. No.: 12/943,864

(22) Filed: Nov. 10, 2010

(51) Int. Cl. H01Q 21/28

(52) U.S. Cl. 343/893

(57) ABSTRACT

A portable antenna structure that employs a plurality of antenna modules that collectively cover a venue and provide telecommunications services to customers within the venue, arranged to produce a plurality of beams that have non-overlapping regions, regions where adjacent beams overlap with each other, and collectively the beams fully cover the venue. Customers that are located at a spot in the venue where only one beam provides coverage are served by that beam, and customers that are located at a spot in the venue where two adjacent beams overlap are served by one of the beams, or both (depending on the technology used) and if appropriate they are handed off from one beam to the other beam in a conventional manner.

### BACKGROUND OF THE INVENTION

This relates to cellular telephony coverage of events where a large number of customers who require significant communication capacity are located in a relatively small area.

There are many situations where large numbers of persons congregate in small areas, and the telecommunications service provider is expected to provide service for those persons. A sports arena and its associated parking facilities is an example of such a venue that most readily comes to mind. The numbers of persons in such a venue typically exceeds the capacity of a conventional cellular telephony base station, which requires the service provider to make special provisions. Such provisions are oftentimes constrained as to the location where antenna facilities can be placed. For example, a communications service provider is not likely to get permission to put an antenna facility in the middle of a football field.

One prior art system that undertook to solve the capacity problem where access to the venue was available only from sides of the venue employs two antenna array structures, as depicted in FIG. 1. Each structure consists of two antenna modules, where each antenna module creates a beam pattern that substantially consists of a single lobe, and collectively the two antenna structures provide coverage to the venue. Antenna structure 10 points toward stadium 20 from the South with 2 beams, and the similar antenna structure 15 points to arena 20 from the North.

Alas, the above-described prior art approach is not very effective because the signals of antenna structure 10 interfere with the signals of antenna structure 15, and vice versa. Additionally, FIG. 1 arrangement is not very effective because the antenna beams are wide, so only two antennas are used in each structure (so as to not have too much overlap between of the beams, and since the capacity of the arrangement is approximately proportional to the number of beams that one usefully brings to bear on the customers, the benefit of the FIG. 1 arrangement is not great.

### SUMMARY OF THE INVENTION

An advance in the art is realized by employing a single antenna structure to provide telecommunication service to the entirety of a venue. The antenna structure includes a plurality of antenna modules, each of which is characterized by a beam pattern having a single significant lobe (beam) that is narrow in the horizontal plane, and the antenna modules are positioned in the structure to create a collective service coverage area that fully subsumes the venue. Advantageously, the beam of each module is not more than 30 degrees between 10 db drop-off points.

In one very useful embodiment the structure is to one side of the venue and the antenna modules are positioned to cover a sector of approximately 180 degrees. Specifically, the antenna structure consists of 6 separate antennas modules, each of which has a beam pattern that consists of a single significant lobe that couples maximum output signal (and is most sensitive to received signals) at a direction that is perpendicular to its front plane (center direction), and the 6 antennas are positioned to point at different directions, with their center directions at directions that are 30 degrees apart, so that the coverage of the venue provides an acceptable level of service to all telecommunication devices within the venue.

In a novel use of some commercial antenna modules that are designed with a beam width in the horizontal plane that is inappropriately wide but happen to have a beam width that is sufficiently narrow in the vertical plane, they are positioned in the antenna structure at 90 degrees relative to their designed orientation.

### BRIEF DESCRIPTION OF THE DRAWING

FIG. 1 shows a prior art antenna arrangement for providing telecommunication service to customers who attend a venue;

FIG. 2 depicts an arrangement in accord with the principles disclosed herein for covering a venue from one side, using six antenna modules that point at directions that are 30 degrees apart; and

FIG. 3 illustrates the overall coverage afforded by the FIG. 2 antenna arrangement; and

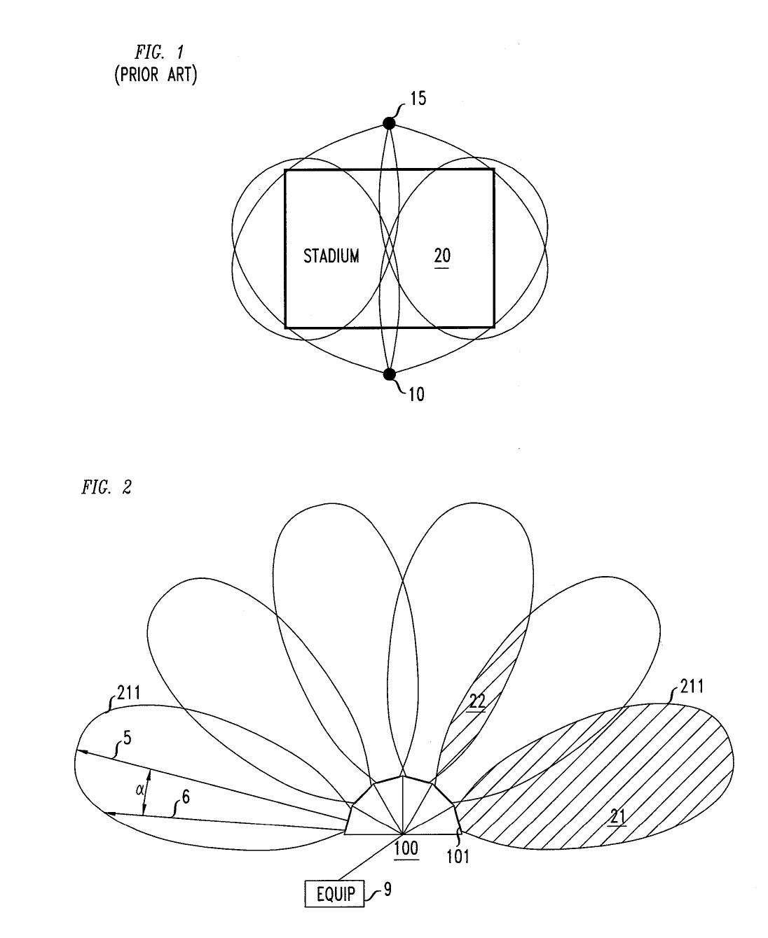

### DETAILED DESCRIPTION

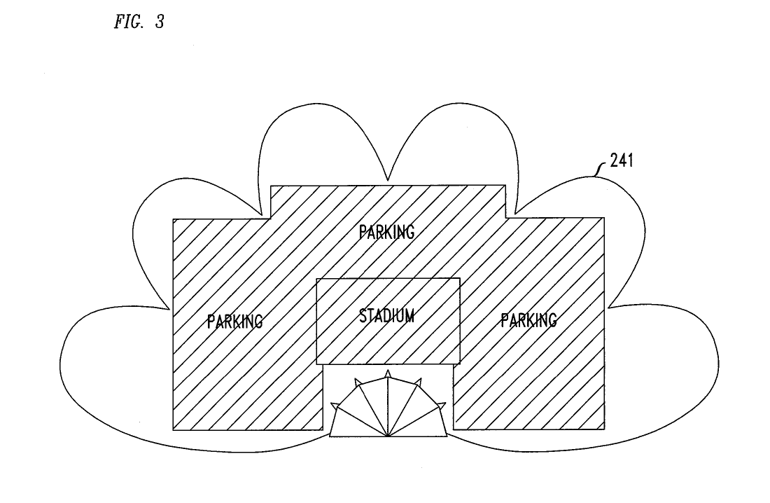

FIG. 2 depicts an arrangement that consists of a structure 100 that illustratively has 6 separate antenna modules 101 which point at directions that are 30 degrees from each other, each producing a beam pattern, where demarcation curve 211 depicts the shape of the single significant lobe 21 of the beam pattern. The FIG. 2 structure is portable—often referred to in the art as cell on wheels (cow)—and it is designed to cover the entirety of a venue from one side of the venue. More specifically, the cow of FIG. 2 is geographically positioned so as to cover the venue, and it has the responsibility to handle the communication traffic of customers that are present in the venue, even in presence of signals from more distant antennas, whose signals are treated as noise.

Demarcation curve 211 can be viewed in terms of antenna gain, or coverage.

In terms of antenna gain, it can be said that the gain at the direction of ray 5, which is the center direction of beam 21 and the direction of maximum gain, is greater than the gain at the direction of ray 6. It is convenient at times to refer to the gains, such as for ray 6, in terms relative to that for the maximum gain, such as ray 5. Gain is almost universally expressed in db's. As such, the relative gain for ray 5 is zero, and other directions are less than zero. For example, the antenna gain of ray 6 may be −10 db.

In terms of antenna coverage, curve 211 delimits a region where the signal of the associated module 101 can be received by a cellphone that is anywhere within the region 21, and the signal of a cellphone that is situated anywhere within region 21 can be received by the associated module 101. Conversely, cellphones outside the region 21 cannot receive the signal (or receive a greatly attenuated signal) of the associated module 101 and the associated module 101 cannot receive the signal (or receive a greatly attenuated signal) of such cellphones. Put another way, for customers to be properly serviced, the sensitivity of equipment 9 that receives signals from an antenna module and the transmitted power of equipment that delivers signals to an antenna module are such that customers within the area subsumed by curve 241 are served, and customers outside that area are not served.

Region 22 is the overlap region between adjacent beams, so customers who are in region 22 are served by either one of the adjacent modules 101. Customers that enter or leave this region are handed off from one of the modules 101 to the adjacent module 101, when appropriate. Such hand-offs are well known in the cellular telephony art.

It is noted that depicted beam patterns are idealized, in that physical antennas that are designed to produce a single significant lobe in the horizontal direction typically produce side lobes that span the full 360 degrees, but the gains of those side lobes are very low so they are inconsequential.

Assuming that the antenna gains produced by module 101 at all directions that are not explicitly depicted in FIG. 2 are −25 db or less, and that signals which are so attenuated do not represent a significant interference noise factor, it follows that the antenna structure of FIG. 2 covers a region as delineated by curve 241 in FIG. 3; and that means that antenna structure 100 can be used to provide service to a venue such as the crosshatched region 24 shown in FIG. 3.

It may be observed that the region subsumed by curve 241 is somewhat fluted and that a larger percentage of the covered area is likely to be usefully employed to cover a venue if there is less fluting. What that means is that it is advantageous to use an antenna module that produces “fatter” lobe. On the other hand, the overlap region is the region within which customers need to be monitored as to whether a hand-off from one antenna module to the adjacent antenna module is called for, and it is beneficial to have the overlap area small so that only few customers must be so monitored. The combination of the two desirable attributes is that the lobe produced by an antenna module should be as wide as possible between zero gain and −3 db gain, and that the lobe's gain should drop off fairly steeply beyond that.

For a typical application, it was concluded that the antenna module should have a lobe with an 18 degree beam width within which the antenna gain is between 0 and −3 db, and a 30 degree beam width within which the antenna gain is between 0 and −10 db. A commercially available antenna module that is acceptable is made by Andrew, a CommScope company, model LBX-3316DS-VTM.

While the FIG. 2 arrangement depicts a cow that covers roughly 180 degrees, and it therefore useful in covering a venue from a side of the venue, it should be understood that a cow can be constructed to cover a span of any other angle, including 360 degrees. Since capacity is roughly proportional to the number of beams that are usefully brought to bear on the crowd of people, if a cow can be put in the center of a crowd, even more beams can be employed and thus more capacity can be provided

1. A telecommunication servicing arrangement comprising:
a portable antenna structure (cow) having operational responsibility for providing telecommunication service to a venue in presence of signals from more distant antennas whose signals are treated as noise, said structure including a plurality of n antenna modules, where an antenna module is characterized by a beam pattern having a single significant lobe that extends at a particular direction relative to structure of the antenna module (center direction), with the antenna modules being positioned in said structure to have their respective center directions pointing at different angles along the horizontal plane toward said venue, so that lobes of adjacent antenna modules intersect at antenna gain levels of not less than −10 db;
said antenna positioned to cover said venue, in combination with equipment coupled to said cow with receive and transmit capabilities adjusted for the lobes of the antenna modules to collectively cover the venue in its entirety.

2. The arrangement of claim 1 where said cow is positioned to a side of said venue.

3. The arrangement of claim 2 where said antenna modules collectively cover a sector of approximately 180 degrees.

4. The arrangement of claim 2 where said cow comprises at least six antenna modules that collectively cover a sector of approximately 180 degrees.

5. The arrangement of claims 1 where each of said antenna modules is designed to be oriented in a specified way relative to the horizon, and said antenna modules are affixed to said portable antenna structure rotated substantially 90 degrees relative to the orientation to which the antenna module were designed.
